(19) United States
(12) Patent Application Publication
(10) Pub. No.: US 2023/0325471 A1
(43) Pub. Date: Oct. 12, 2023

(54) MULTI-THREAD OF UPWARD BOW POSE MACHINE LEARNING FOR MULTI-TENANT TIME SERIES DATABASE

(71) Applicant: International Business Machines Corporation, Armonk, NY (US)

(72) Inventors: Meng Wan, BEIJING (CN); Sheng Yan Sun, BEIJING (CN); Peng Hui Jiang, BEIJING (CN); Hong Mei Zhang, Haidian District (CN)

(21) Appl. No.: 17/715,190

(22) Filed: Apr. 7, 2022

(51) Int. Cl. G06K 9/62; G06F 16/2458; G06N 3/08

(52) U.S. Cl. CPC G06K 9/6215; G06K 9/6219; G06K 9/628; G06F 16/2477; G06N 3/08

(57) ABSTRACT

A supervised similarity measure machine learning method, system, and computer program product that includes generating embeddings by training a supervised deep neural network (DNN) on a feature data to determine which nodes correspond to which clustered learning group of clustered learning groups, performing half-distributed learning by distributing data in a time-series database to the clustered learning groups, and evaluating, based on the embeddings, new tenant data in the clustered learning groups with an upward bow pose.

### BACKGROUND

The present invention relates generally to a supervised similarity measure machine learning method, and more particularly, but not by way of limitation, to a system, method, and computer program product to perform supervised similarity measure deep neural network (DNN) learning for tenant clustering and distributed continuous (A-B) learning for time-series database in Upward Bow Pose.

A time series database is a database which stores time-label data. Time series databases are mainly used for entities of big data requirement, but many uses exist such as weather prediction, healthcare data, network center failures, etc. The industrial data is generated quickly in second and depends on sampling time. Even several gigabytes (GB) of data will be collected in real-time monitor system every day. Multi-tenancy includes an architecture in which a single instance of a software application serves multiple customers. Each customer is called a tenant.

In a multi-tenant architecture, multiple instances of an application operate in a shared environment. This architecture is able to work because each tenant is integrated physically, but logically separated. Thereby, a single instance of the software will run on one server and then serve multiple tenants. Thus, multi-tenant architecture has been conventionally important for cloud computing in public cloud or private cloud as multi-tenant architecture can save a lot of effort for tenants (e.g., pricing model of pay-for-what-you-need, updates systems scalable, etc.).

Time series database technology also adopts multiple-tenant architecture because of the advantages above. However, conventional time series database technology lacks flexibility for application in single-tenant architecture, especially for smart learning for data in time series database.

With the fast development in cloud technology, more applications have been developed based on database, but less application can be focused on time-serial database. Some conventional solutions can handle the data in database, but the conventional solutions cannot integrate and separate the multi-tenant's information for AI learning.

The conventional solutions may take care of the single-tenant data, but the conventional solutions can't generate a meaningful learning for a big environment when considering the neighbor or similar tenant. On the other hand, the strategy may take care all the tenants' data, but this learning may lack for customization.

Therefore, there is a technical problem in the art for how to figure out a high-efficient learning process for multi-tenant in time-series database.

### SUMMARY

In view of the above-mentioned problems in the art, the inventors have considered a technical solution to the technical problem in the conventional techniques by providing a technique to perform multi-thread learning and scoring based on a learning for processed time series data in Upward Bow Bose learning for business and customer trend analysis.

In an exemplary embodiment, the present invention can provide a computer-implemented supervised similarity measure machine learning method, the method including generating embeddings by training a supervised deep neural network (DNN) on a feature data to determine which nodes correspond to which clustered learning group of clustered learning groups, performing half-distributed learning by distributing data in a time-series database to the clustered learning groups, and evaluating, based on the embeddings, new tenant data in the clustered learning groups with an upward bow pose.

In an alternative exemplary embodiment, the present invention can provide a supervised similarity measure machine learning computer program product, the supervised similarity measure machine learning computer program product comprising a computer-readable storage medium having program instructions embodied therewith, the program instructions executable by a computer to cause the computer to perform: generating embeddings by training a supervised deep neural network (DNN) on a feature data to determine which nodes correspond to which clustered learning group of clustered learning groups, performing half-distributed learning by distributing data in a time-series database to the clustered learning groups, and evaluating, based on the embeddings, new tenant data in the clustered learning groups with an upward bow pose.

In another exemplary embodiment, the present invention can provide a supervised similarity measure machine learning system, said supervised similarity measure machine learning system including a processor and a memory, the memory storing instructions to cause the processor to perform: generating embeddings by training a supervised deep neural network (DNN) on a feature data to determine which nodes correspond to which clustered learning group of clustered learning groups, performing half-distributed learning by distributing data in a time-series database to the clustered learning groups, and evaluating, based on the embeddings, new tenant data in the clustered learning groups with an upward bow pose.

In another exemplary embodiment, the present invention can provide a computer-implemented supervised similarity measure machine learning method, the method including generating embeddings by training a supervised deep neural network (DNN) on a feature data and triggering a re-learning of the embeddings via the DNN based on evaluating new tenant data in the clustered learning groups with an upward bow pose.

In another exemplary embodiment, the present invention can provide a computer-implemented supervised similarity measure machine learning method, the method including generating embeddings by training a supervised deep neural network (DNN) on a feature data to determine which nodes correspond to which clustered learning group of clustered learning groups and performing multi-thread scoring and learning to re-learn the embeddings based on an evaluation and a prediction for new tenant data of a first thread being different than an evaluation and a prediction of the new tenant data of a second thread.

In another exemplary embodiment, the upward bow pose triggers for the embeddings to be re-learned based on an analysis of a probability matrix that is generating based on the embeddings.

In another exemplary embodiment, the upward bow pose triggers for the embeddings to be re-learned when a node owning the data never has a chance to catch the data.

In another exemplary embodiment, wherein the upward bow pose triggers for the embeddings to be re-learned based on a scoring gap in a probability matrix generated using the embeddings.

Other details and embodiments of the invention will be described below, so that the present contribution to the art can be better appreciated. Nonetheless, the invention is not limited in its application to such details, phraseology, terminology, illustrations and/or arrangements set forth in the description or shown in the drawings.

Rather, the invention is capable of embodiments in addition to those described and of being practiced and carried out in various ways and should not be regarded as limiting.

As such, those skilled in the art will appreciate that the conception upon which this disclosure is based may readily be utilized as a basis for the designing of other structures, methods and systems for carrying out the several purposes (and others) of the present invention. It is important, therefore, that the claims be regarded as including such equivalent constructions insofar as they do not depart from the spirit and scope of the present invention.

### BRIEF DESCRIPTION OF THE DRAWINGS

Aspects of the invention will be better understood from the following detailed description of the exemplary embodiments of the invention with reference to the drawings, in which:

FIG. 1 exemplarily shows a high-level flow chart for a supervised similarity measure machine learning method 100 according to an embodiment of the present invention;

FIG. 2 exemplarily depicts a flowchart for DNN similarity measure according to an embodiment of the present invention;

FIG. 3 exemplarily depicts types of DNNs that can be selected according to an embodiment of the present invention;

FIG. 4 exemplarily depicts time series data according to an embodiment of the present invention;

FIG. 5 exemplarily depicts clustered learning groups according to an embodiment of the present invention;

FIG. 6 exemplarily depicts separation of the tenants from the provider where the provider clusters the tenants into the clustered learning groups according to an embodiment of the present invention;

FIG. 7 exemplarily depicts an architecture for half-distributed learning according to an embodiment of the present invention;

FIG. 8 exemplarily depicts an algorithm for model merge on cluster groups using half-distributed learning according to an embodiment of the present invention;

FIG. 9 exemplarily depicts one vs. one multiclassification according to an embodiment of the present invention;

FIG. 10 exemplarily depicts an upward bow pose learning transfer triggering according to an embodiment of the present invention;

FIG. 11 exemplarily depicts a probability matrix according to an embodiment of the present invention;

FIG. 12 exemplarily depicts a prediction variance for triggering a re-learning via multi-thread learning and scoring according to an embodiment of the present invention;

FIG. 13 exemplarily depicts threads of the multi-thread learning and scoring according to an embodiment of the present invention;

FIG. 14 depicts a cloud computing node 10 according to an embodiment of the present invention;

FIG. 15 depicts a cloud computing environment 50 according to an embodiment of the present invention; and

FIG. 16 depicts abstraction model layers according to an embodiment of the present invention.

### DETAILED DESCRIPTION

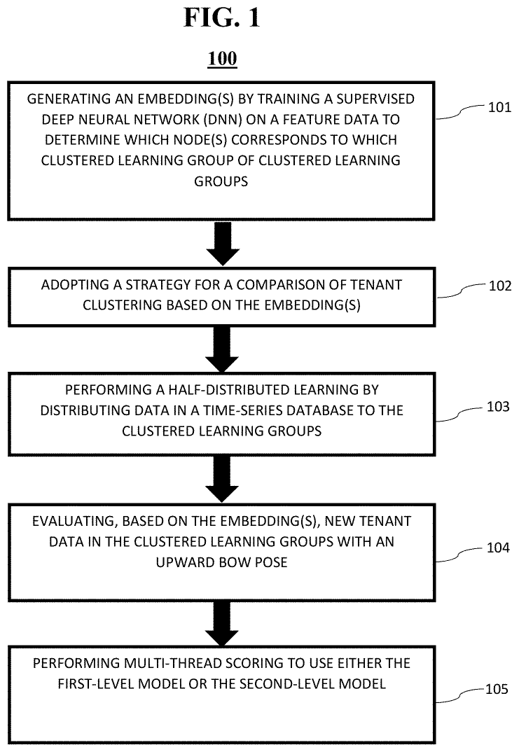

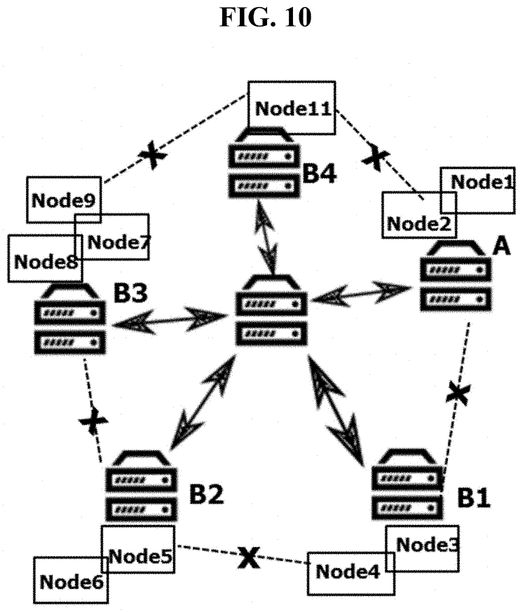

The invention will now be described with reference to FIGS. 1-16, in which like reference numerals refer to like parts throughout. It is emphasized that, according to common practice, the various features of the drawing are not necessarily to scale. On the contrary, the dimensions of the various features can be arbitrarily expanded or reduced for clarity.

With reference now to the exemplary method 100 depicted in FIG. 1, the invention includes various steps for a system that provides a supervised similarity measure deep neural network (DNN) learning for tenant clustering and distributed continuous learning for time-series database in upward bow pose including DNN embeddings, half-distributed learning, upward bow pose learning, and multi-thread scoring.

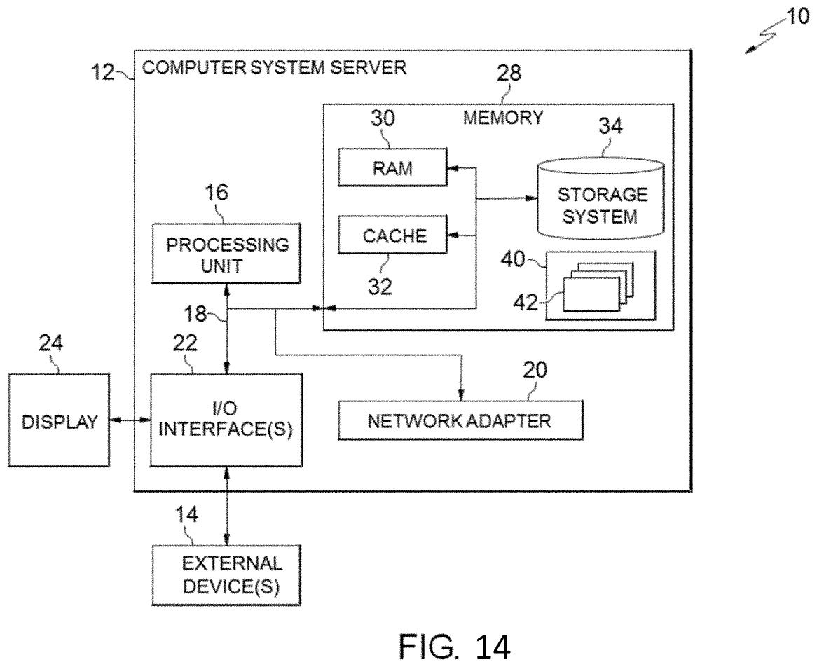

As shown in at least FIG. 14, one or more computers of a computer system 12 according to an embodiment of the present invention can include a memory 28 having instructions stored in a storage system to perform the steps of FIG. 1.

The supervised similarity measure machine learning method 100 according to an embodiment of the present invention may act in a more sophisticated, useful and cognitive manner, giving the impression of cognitive mental abilities and processes related to knowledge, attention, memory, judgment and evaluation, reasoning, and advanced computation. A system can be said to be “cognitive” if it possesses macro-scale properties—perception, goal-oriented behavior, learning/memory and action—that characterize systems (i.e., humans) generally recognized as cognitive.

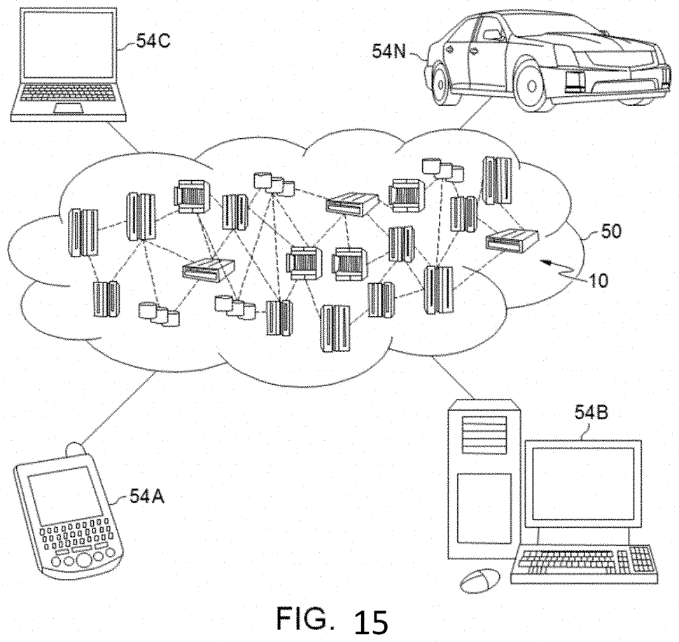

Although one or more embodiments (see e.g., FIGS. 14-16) may be implemented in a cloud environment 50 (see e.g., FIG. 15), it is nonetheless understood that the present invention can be implemented outside of the cloud environment.

It is noted that “node” and “tenant” are used interchangeably. That is, “nodes” or “tenants” are clustered together (or are the only one) into “clustered learning groups”.

With reference generally to FIGS. 1-13, the invention can provide a technique to perform multi-thread learning and scoring based on a learning for processed time series data in upward bow pose learning for business and customer trend analysis. Also, a separated cluster group (K group(s)) is constructed according to the half-distributed learning, then the cluster group is used for the multi-thread learning input and self-evaluation and predication dynamically in the group. Finally, a useful prediction can happen in the invention to help business or customer trend analysis. Thereby, via steps 101-105, a multi-tenant time-series database data engineering problem is solved by having supervised similarity measure DNN for tenant groups and distributed continuous learning in Upward Bow Pose way to machine learning with deep learning.

More specifically, in steps 101-102, embeddings are generated by training a supervised deep neural network (DNN) on the feature data itself to determine which nodes correspond to which clustered learning group of clustered learning groups. The embeddings map the feature data to a vector in an embedding space. Then, a strategy is adopted for similarity comparison of tenant clustering.

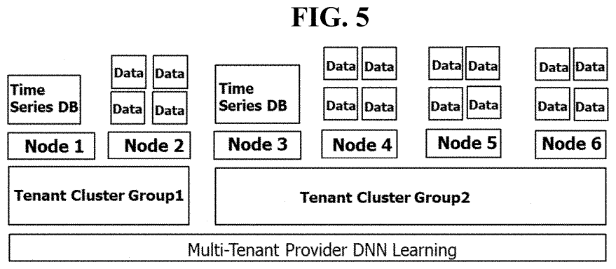

For example, it is determines whether nodes 1-2 of nodes 1-6 should be clustered together to form “clustered learning group” (i.e., tenant cluster group 1 of FIG. 5). Or, whether tenant cluster group 1 should include nodes 1 and 3.

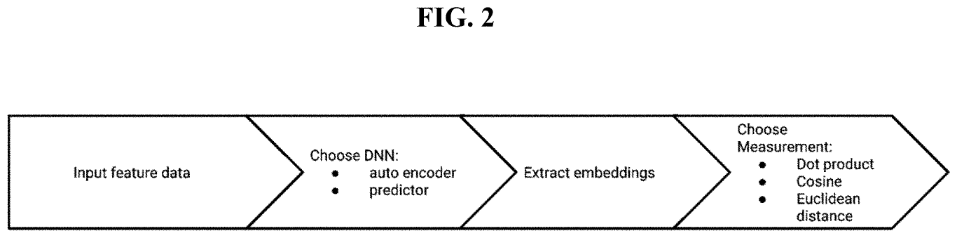

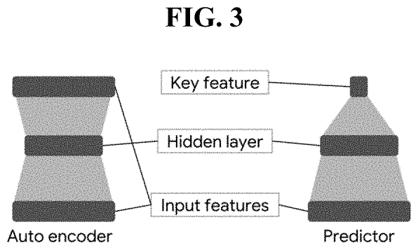

For the DNN similarity and clustering of steps 101-102, with reference further to FIGS. 2-5, the DNN automatically eliminates redundant information and combines features. And, the DNN is chosen based on training labels where a DNN that learns embeddings of input data by predicting the input data itself is called an autoencoder (e.g., see FIG. 3). A predictor (as shown in FIG. 3) is when this DNN predicts a specific input feature instead of predicting all input features.

Because an autoencoder's hidden layers are smaller than the input and output layers, it prefers numeric features to categorical features as labels because loss is easier to calculate and interpret for numeric features. Also, categorical features with cardinality less than or equal to 100 as labels are required as, if not used, the DNN will not be forced to reduce the input data to embeddings because a DNN can easily predict low-cardinality categorical labels. Also, the feature that is used as the label from the input to the DNN is removed; otherwise, the DNN will perfectly predict the output.

More specifically, regarding the DNN step, the invention needs some input feature data. Then, the invention can select a type of a DNN (i.e., auto encoder, predictor, etc.) to do deep learning. Then, the invention extracts embeddings from the DNN to make the embeddings into a vector and the invention learns from the vectors to combine for the similarity (i.e., DNN similarity measure).

In other words, each group of clustered learning groups can contribute to a federated model. This means a group will have its federated model. So, the half-distributed learning is what help contribute the federated model for each group. That is, the invention performs half-distributed learning by distributing data in a time-series database to the clustered learning groups where every learning group can contribute to a model in one group after half-distributed learning. Then, the evaluating evaluates new tenant data in the models of cluster learning groups with an upward bow pose.

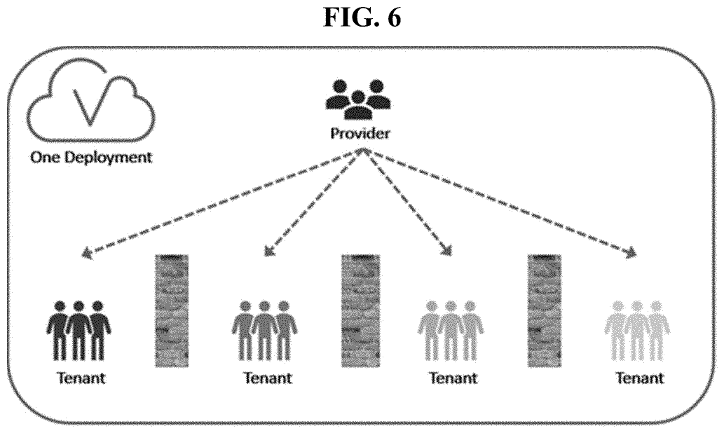

An important aspect of the DNN similarity measure in step 101 is the feature data of the first step. The invention wants to input data that is from a tenant, and not shared between each other (e.g., see FIG. 6 in which the tenants cannot see each other data but the invention has the data input). The learning engine can see all the data even though it is not shared between the tenant.

Then, the invention combines the data records to do the cluster based on the clustering (e.g., see FIG. 5 showing “tenant cluster group 1” and “tenant cluster group 2”). That is, as shown in FIG. 5, node 1 and node 2 are clustered as part of tenant cluster group 1. Nodes 3-6 are clustered into tenant cluster group 2.

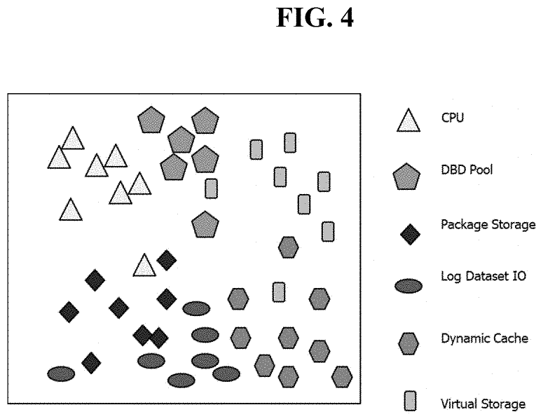

For example, the invention clusters a row with values for CPU, DBD Pool, package, and storage (e.g., see FIG. 4).

Therefore, data caught each time from different a tenant (first row tenant 1, second row tenant 2, etc.), then there are two tenant rows, and the input data is cached for the DNN learning. The tenant is made distributed on the cluster group. Therefore, the clusters have some CPU, DBD pool, package storage based on columns. So, the DNN with similarity measure decides which node should be in which cluster (i.e., the DNN can help generate the vector, but the cluster can be generated after the similarity comparison based on the DNN vector).

In step 103, half-distributed learning is performed by distributing data in a time-series database to clustered learning groups and each group determines a first-level model for features analysis.

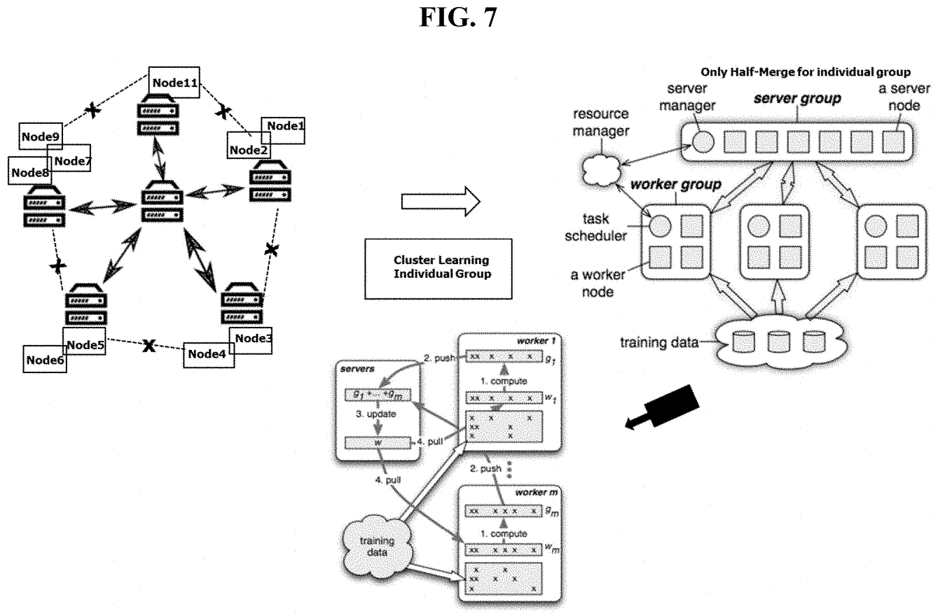

For the half-distributed learning of step 103, the system includes some server nodes and worker nodes. Data in time-series database is distributed to clustered learning groups and each group can figure out the “first-level A model(s)” (i.e., a first model) for features analysis. Each worker node loads a subset of data with different workers loading different samples. Each worker computes gradients on the local data for optimizing the loss function. Each worker then sends those partial gradients to the server node. Server node aggregates those gradients received from many worker nodes (e.g., see FIG. 7).

More specifically, clusters are formed then with clusters of nodes 1-2, node 3-4, nodes 5-6, nodes 7-9, and node 11 are shown in FIG. 7. After this, the invention has learning not just on one cluster but on different clusters across the different clusters. So, the invention performs distributed learning across the clusters. As shown in FIG. 7, each cluster has a different infrastructure (top right), where the invention has workers (three depicted in FIG. 7). Preferably, the cluster has a 1:1 ratio of worker to node such that the depicted represents the cluster with nodes 7-9. The invention learns workers 1 data, worker 2 data, etc. Then, the invention merges the different worker data result. Data is different on a different worker, so worker 1 needs to contribute values to server, worker 2 contributes to server, then server has to “merge” them. The final result is of the model parameter, and different models based on different cluster.

It is noted that, for the merging of the models, node 1 and node 2 merge together because they are in a cluster but not merged with nodes 3-4 (i.e., the “half” of “half-distributed learning”). The output of all the merges is that there isn't a second merge (i.e., full merge). Thus, step 103 outputs a model for each one of the clusters and the models are (five models in the example above) the output.

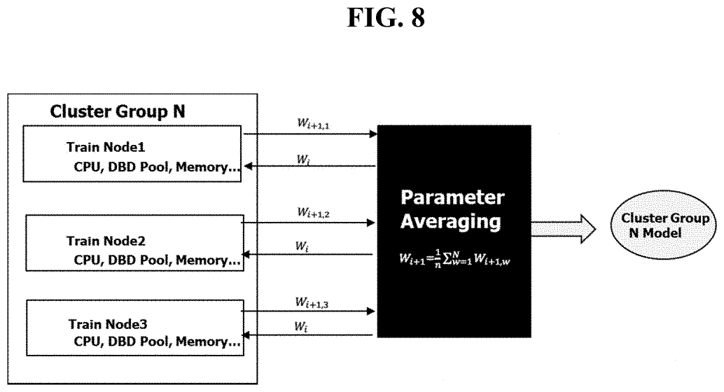

To merge the models on the cluster group, equation (1) is used in reference to FIG. 8.

$${W}_{i + 1} = \frac{1}{n} {\sum }_{w = 1}^{n} {W}_{i + 1 , w} = \frac{1}{n} {\sum }_{w = 1}^{n} ( {W}_{i} - \frac{α}{m} {\sum }_{j = ( w - 1 ) m + 1}^{wm} \frac{\partial {L}^{j}}{\partial {w}_{i}} ) = {W}_{i} - \frac{α}{nm} {\sum }_{j = 1}^{nm} \frac{\partial {L}^{j}}{\partial {w}_{i}} \qquad ( 1 )$$

The variables are defined such that W is the model parameter for weight value, w is the index for the worker, i is the version index for iteration learning, e.g., i=1 is the first learning, i=2 is the second learning, a is learning rate, n is the workers number, e.g., each tenant in the cluster group will be a worker, m is the sample size for each worker learns, and ∂L/∂w is the partial differential equation.

In step 104, upward bow pose learning is performed by evaluating new tenant data in separated cluster groups with upward bow pose. A greatest metric result of the cluster group has a chance to catch the data and the second-level model are determined.

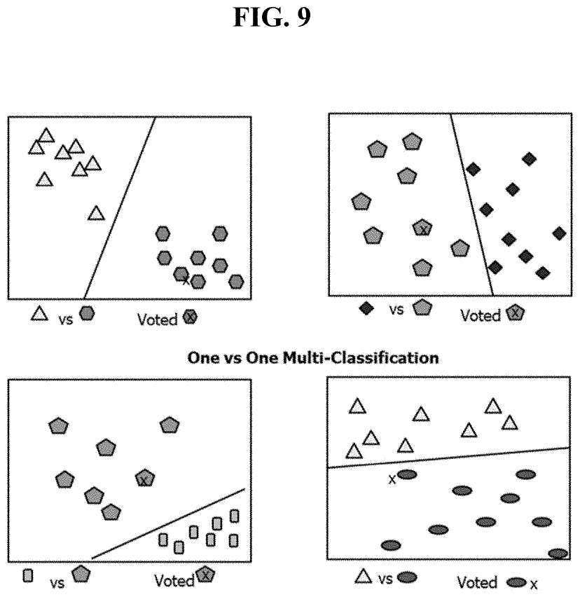

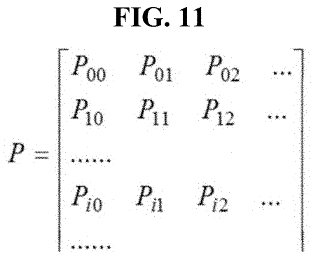

For the upward bow pose of step 104, new tenant data is evaluated in separated cluster group (K-groups) with an upward bow pose. A highest metric result of the cluster group has the chance to catch the data and the “second-level B model(s)” (i.e., a second model) are figured out with the following. With one vs. one multi-classification (e.g., see FIG. 9), the new data is dropped into the highest-metric cluster group. Also, a state transition matrix is built for the M order [N, N-1, . . . . , N-M] data points of K*K matrix for learning (e.g., see FIG. 11).

More specifically regarding “upward bow pose”, upward bow pose learning includes three features. “Feature 1” where there is no need to take care for history, only relate with the last status node. “Feature 2” where stable rule based on evaluation metric among learning group. And, “Feature 3” includes status (metric), reward (absorb data−1<metric 21 1), action (iteration learning with delta data), transfer (reorganize learning group data distribution).

For feature 1, this means data learning, don't need to take care of the history. History has been learned. So, there is nothing to be done. For feature 2, stable rule is how to handle the data and how the data should be handled. The decision is based on the stable rule.

Feature 3 has four elements where the invention looks at status of a metric and contributes to the rule (metric is machine learning and how the model is such that if metric is higher, then model is good). Reward is based on if the data coming out of the model and the model thinks the data is good because the metric is good, then the model can reward that. Data may be good for class 1 but not class 2. Then action, the invention may have something happen and needs to iterate learning because data is coming turn to turn. After data is stable, the invention may have stable iteration for system. Lastly, for transfer, data points assigned to cluster may not always be assigned to same cluster because of an exception. So, LUA (e.g., programming language) is used to check if the invention always wants to always assign data to a cluster.

Regarding FIG. 9, the top left image shows different icons representing a different cluster—leverage one machine learning method one to one multiclassification. Triangles represent cluster group 1 and hexagons represent cluster group 2. The top left image shows that the hexagons are chosen for the data (i.e., the “x”). Then, data should be compared for other data groups from other model to then see what is chosen. Based on this, the hexagon owns the data again when comparing to the diamonds (top right) and then compares to the rectangles in bottom left, but the hexagons still own the data. In the last one, triangle vs. circle, circle owns the data. So, after all the combinations happen with the clusters, each one should have a ticket. The winner is shown with X. So, hexagon gets 3 tickets, circle gets 1 ticket. Then, the invention combines which shape icon has most tickets and it wins to own the data finally. The last winner will have most selections.

In other words, FIG. 9 is to make the data knows which cluster group it will go. This is to build/scoring on the first-level A model. And the next P matrix with highest probability is to make the system know which other cluster group the data can probably also go, this is to build/scoring on the second-level B model.

For the P matrix, P means probability. The P matrix shown in FIG. 11 consists of different probabilities. P01 means probability if the data of cluster 0 is sent to cluster 1. That means, whether the data should be transferred from cluster 0 to cluster 1. The invention includes a LUA to tell one about the value. P02 is larger than P01, then data should go to class 0 because probability is higher for P01. Reward data is what happens if one has the P02 larger than P01.

The matrix of FIG. 11 includes P for B models data hand out that indicates the probability when a new data is absorbed into a Group.

Data is rewarded to the clustering group with the highest probability P in the matrix above. For the P matrix, i, j is the cluster group index and metric with g(i) presents the model metric result when assuming the data flows into the cluster i. O_dis presents the distance between cluster group i and cluster group j. The P matrix math equations are below as equations (2) and (3).

$$P ( {x}_{1} \text{?} {x}_{2} , … … , {x}_{N} ) = P ( {x}_{2} \vert {x}_{1} ) {\prod }_{n = 3} P ( {x}_{n} \vert {x}_{n - 1} , {x}_{n - 2} ) \qquad ( 2 )$$

$${P}_{i , j} = \{ \begin{matrix}{Metric}_{g ( i )} , i = j \\ \vert {Metric}_{g ( i )} / O \_ dis \{ i , j \} \vert \cdot {Metric}_{g ( i )} , i \neq j \\ {P}_{ij}\end{matrix} \qquad ( 3 )$$

$$\text{?} \text{indicates text missing or illegible when filed}$$

For example, based on the matrix as shown in FIG. 11, in a situation if data from node 1 originally has data as original owner, but the data may be more similar with node 11. So, the invention can assign it to node 11 instead of node 1. But, it is determined where the data should go based on the probability matrix (e.g., see FIG. 11). Pii is the data on node 1. Pij, is what happens if data is assigned to another cluster (so data goes to j instead of i), then the invention uses matrix j with matrix Ito do a cluster and distance normalized. The DNN result from step 101 is the vector, and that is how one figures out a distance in this step 104 (vector i and vector j). In this example, the probability matrix is generated, and the invention will know which cluster should have the data based on the largest probability from the probability matrix. So, the largest probability will own the data (i.e., node with largest probability). The node with the largest probability loses the chance to catch the data if that is not the highest. So, every data coming into the system, will trigger the matrix generation and the last probability will show where the winner to catch the data. The probability depends on the last matrix that is made from the metric combined with cluster groups' vector distance. Therefore, the matrix iterates.

In other words, the probability needs two elements where a first element is the distance between DNN vectors and the other element is the metric values generated by the group models when a data is flowing into cluster groups. For example, the vector distance between I and J group [vector i, vector j]−>Distance[i,j], the distance between center i and center j is calculated. Model metrics value in each cluster group is metric(i)*metric(j). And, after one has the two values, one can determine the probability P[i,j]. This is represented in the equations (2) and (3).

The transfer triggers when a phase iteration model evaluation performs [long-time] metric B(i)>A model. That is, if metric b(i), and (bi)>a model (node 1 and node 2) to a different cluster and not to itself, then the system may have a problem where it only assigns the data to others and the owner never has a chance to catch its data. Therefore, this metric shows that the data may have an issue. The node should have a chance to catch itself. So, in this case, the invention triggers a transfer where the invention retrieves the data back to node 1 or moves node 1 to a different cluster because the data should be near its owner. This is the first learning for the model.

Or, a transfer can be triggered based on a phase iteration scoring performed that has a large gap in the models so then the clusters are re-arranged which means the matrix for A is nearly 0.01 and B4 is 0.99. The matrix of FIG. 11 having this data means that performance is very different between clusters so that the model system does not fit for the data such that the invention needs to trigger a transfer to move the nodes to clusters.

To perform the transfer, the invention repeats the DNN of step 101 and re-trains tenants because node 1 isn't always good on tenant cluster 1. That is, the invention re-trains the model. So then, back in the DNN, node 1 may be re-clustered to be in cluster 2 not cluster. The invention can repeat steps 101-104 with this better model that gives better result. Insomuch as, the invention can learn during the DNN, then re-learn based on the upward bow pose learning. The invention can re-learn to move the nodes or even to create a new cluster altogether.

In step 105, multi-thread scoring is performed to use either the first-level model or the second-level model. For the multi-thread learning and scoring of step 105, either the first model or second model can work for prediction. The invention doesn't vote any prediction result until the practical results are close to each other. Self-evaluation and predication dynamically happen in the K-group and multi-thread scoring with the first model and the second model. And, an evaluation result Eval[A]<Eval[Bi] for a threshold time exceeds [daily, weekly or specified] time to trigger a new thread learning to build the first model and the second model again.

More specifically, before step 105, learning just happened in single thread which was learning on the original data (i.e., the matrix). Evaluation is performed in that the data should have a label or flag sent to the system. Then, the system predicts the label data. If the two values match, then the evaluation is good. Step 105 evaluates, predicts, and see if they match. Step 105 can use data such as eyes, nose, etc., to predict a determining figure about a person. And, the invention iterates and predicts from time to time. Therefore, step 105 evaluates, predicts, and then retrains if it is not acceptable. Therefore, the model is dynamically adjusted.

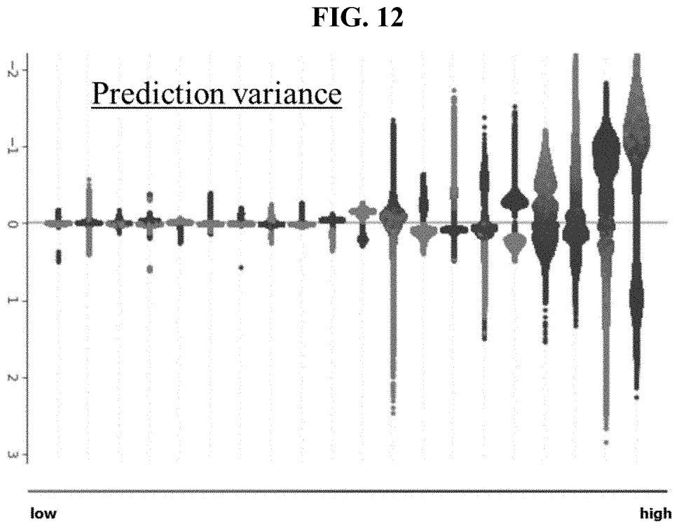

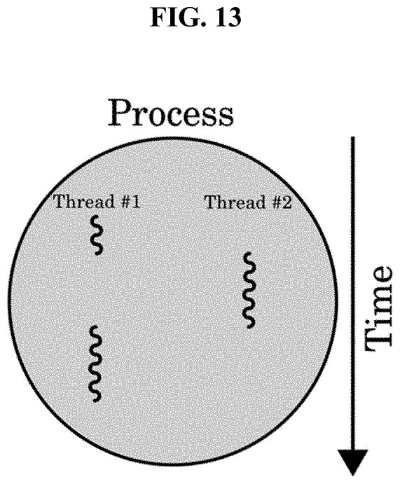

For the multi-thread learning as shown in FIGS. 12-13, it is also determined when and how to evaluate. For example, when thread 1 “A” is original owner, A is evaluated and predict A node for node 1.

Then, in thread 2 (other cluster), step 105 performs an iteration for the data from node A on node B, so step 105 evaluates B and predicts B (which cluster) so then if eval of A<eval of B, then a transfer is triggered. It is noted that the transfer is trigger when the eval of A<eval of B but after a time threshold exceeds. That means it doesn't happen immediately when eval of A<eval of B. It must the duration time exceeds the threshold that is set.

Also, one can set a threshold to dynamically do this based on day, week, year, etc. and customer environment to do this. A bank may want to do it every day while another company doesn't refresh daily, so they may do it weekly. Or, a large variance can be shown such as in FIG. 12 and if line has more variance, than this should be performed more often.

In one exemplary use case using the method disclosed above, an exemplary investment recommendation application stores the customer's data from different tenants. The different tenants may be from different countries or regions (e.g., customers from different clusters may have different investment tendencies). And, for a multi-tenant database system, the application can see or learn all data in the database system though the data can be from different tenants. For example, a customer from developed countries may prefer to invest in a technology-based industry, and the customer from tropical countries may prefer to invest in agriculture/food.

The learning system of method 100 may categorize the customers' data into different clusters by leveraging the DNN embedding. This is to make the learning happen in each cluster for the rest of the method 100. The learning based on each cluster has more exact targeted performance/prediction. In other words, the application will try to learn each cluster customers' data to help recommend them with targeted members. Basically, the invention can know the data from the same tenant/regions could probably divided into the same cluster.

The method includes advanced learning performed after the above is complete. During the learning phase, the labeled data incoming is used for evaluation. The data without a label is called “prediction on the data”. Evaluation is a learning phase and prediction is a model prediction utilization phase.

For evaluation (i.e., step 104), the learning that happens in the cluster where the data is categorized is called “Model A thread learning”. So, the labeled data is first learnt by the Model A process/thread. Since one knows that a customer's investment feature can probably be more similar with the other clusters, one needs to have the other thread B learning to make the data be learnt by other clusters where the data is not categorized. In other words, a customer from developed countries may also like agriculture investment, and a customer from tropical countries may also prefer to the technology industry. The investment tendency is actually affected by many elements, for example, the region, age, customer's enterprise scale/financial plan. This is why the invention utilizes the thread A and thread B to make the learning have more coverage as much as possible.

It is noted that evaluation is for validation, but prediction is for a future event guess. The evaluation is actual validation phase or action, which can judge if the model is good or bad for the learning data. In the example above, the evaluation is validating which cluster is more suitable for the incoming data. If the evaluation result with the data is highest in a cluster, the invention can know the cluster model that is best for the data, thus the model should own the data as its learning element. On the other hand, the evaluation is not good in the cluster if it gets a data, thus the cluster should not have the chance to own it.

Based on the above, the invention then includes upward bow pose machine learning in thread B. The upward bow pose machine learning is to make the customer's data learnt by every other cluster to learn his investment tendency as more as possible. But, it is assumed that the cluster with highest learning metric can finally own the data as its investment learning element. Thus, Model A and Model B are both learning the customer's investment tendency which can help optimize the Model A and Model B.

And, for prediction (i.e., step 105), because the invention has made every cluster to have the chance of learning the customer's investment tendency, the prediction can happen on both of Models/threads when a new customer data without label comes. Thread A and Thread B will both make recommendation/prediction for the new coming customer data. This includes a recommendation supplement between thread A and thread B. The customer will know and choose which thread have more exact predicted recommendation for them.

### Exemplary Aspects, Using a Cloud Computing Environment

Although this detailed description includes an exemplary embodiment of the present invention in a cloud computing environment, it is to be understood that implementation of the teachings recited herein are not limited to such a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client circuits through a thin client interface such as a web browser (e.g., web-based e-mail) The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

Referring now to FIG. 14 a schematic of an example of a cloud computing node is shown. Cloud computing node 10 is only one example of a suitable node and is not intended to suggest any limitation as to the scope of use or functionality of embodiments of the invention described herein. Regardless, cloud computing node 10 is capable of being implemented and/or performing any of the functionality set forth herein.

Although cloud computing node 10 is depicted as a computer system/server 12, it is understood to be operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop circuits, multiprocessor systems, microprocessor-based systems, set top boxes, programmable consumer electronics, network PCs, minicomputer systems, mainframe computer systems, and distributed cloud computing environments that include any of the above systems or circuits, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing circuits that are linked through a communications network. In a distributed cloud computing environment, program modules may be located in both local and remote computer system storage media including memory storage circuits.

Referring again to FIG. 14, computer system/server 12 is shown in the form of a general-purpose computing circuit. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or catch memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external circuits 14 such as a keyboard, a pointing circuit, a display 24, etc.; one or more circuits that enable a user to interact with computer system/server 12; and/or any circuits (e.g., network card, modem, etc.) that enable computer system/server 12 to communicate with one or more other computing circuits. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, circuit drivers, redundant processing units, external disk drive arrays, RAID systems, tape drives, and data archival storage systems, etc.

Referring now to FIG. 15, illustrative cloud computing environment 50 is depicted. As shown, cloud computing environment 50 comprises one or more cloud computing nodes 10 with which local computing circuits used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing circuit. It is understood that the types of computing circuits 54A-N shown in FIG. 15 are intended to be illustrative only and that computing nodes 10 and cloud computing environment 50 can communicate with any type of computerized circuit over any type of network and/or network addressable connection (e.g., using a web browser).

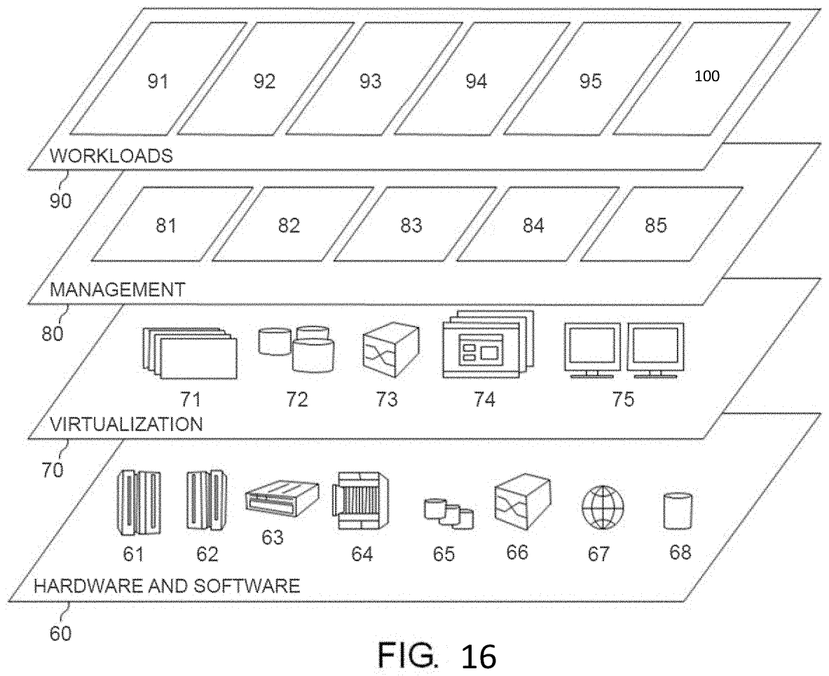

Referring now to FIG. 16, an exemplary set of functional abstraction layers provided by cloud computing environment 50 (FIG. 15) is shown. It should be understood in advance that the components, layers, and functions shown in FIG. 16 are intended to be illustrative only and embodiments of the invention are not limited thereto. As depicted, the following layers and corresponding functions are provided:

Hardware and software layer 60 includes hardware and software components. Examples of hardware components include mainframes 61; RISC (Reduced Instruction Set Computer) architecture based servers 62; servers 63; blade servers 64; storage circuits 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and, more particularly relative to the present invention, the supervised similarity measure machine learning method 100.

The present invention may be a system, a method, and/or a computer program product at any possible technical detail level of integration. The contribution evaluation computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Further, Applicant's intent is to encompass the equivalents of all claim elements, and no amendment to any claim of the present application should be construed as a disclaimer of any interest in or right to an equivalent of any element or feature of the amended claim.

What is claimed is:

1. A computer-implemented supervised similarity measure machine learning method, the method comprising:
generating embeddings by training a supervised deep neural network (DNN) on a feature data to determine which node corresponds to which clustered learning group of a plurality of clustered learning groups;
performing half-distributed learning by distributing data in a time-series database to the clustered learning groups; and
evaluating, based on the embeddings, new tenant data in the plurality of clustered learning groups with an upward bow pose.

2. The computer-implemented supervised similarity measure machine learning method of claim 1, wherein each clustered learning group of the plurality of clustered learning groups determines a first-level model for features analysis.

3. The computer-implemented supervised similarity measure machine learning method of claim 1, wherein the embeddings map the feature data to a vector in an embedding space.

4. The computer-implemented supervised similarity measure machine learning method of claim 1, wherein a cluster learning group with a greatest metric result of the plurality of cluster learning groups output from the evaluating has a chance to catch the data first.

5. The computer-implemented supervised similarity measure machine learning method of claim 2, wherein a cluster learning group with a greatest metric result of the plurality of cluster learning groups output from the evaluating has a chance to catch the data first.

6. The computer-implemented supervised similarity measure machine learning method of claim 5, further comprising determining a second-level model using a one vs. one multi-classification to drop the new tenant data into the cluster learning group having the greatest metric result.

7. The computer-implemented supervised similarity measure machine learning method of claim 5, further comprising determining a second-level model using a built state transition matrix for M order data points of a K*K matrix for learning.

8. The computer-implemented supervised similarity measure machine learning method of claim 6, further comprising performing a multi-thread learning and scoring using either of the first-level model and the second-level model by evaluating an evaluation label for the new tenant data, predicting a predicted label for the new tenant data, and iterating the first-level model and the second-level model when the evaluation label is not a match to the predicted label.

9. The computer-implemented supervised similarity measure machine learning method of claim 1, wherein the half-distributed learning is performed on each clustered learning group of the clustered learning groups separate from others of the clustered learning groups such that a first-level model for a feature analysis includes a model for said each clustered learning group.

10. The computer-implemented supervised similarity measure machine learning method of claim 9, wherein half-distributed learning includes:
a plurality of workers computing gradients on local data for optimizing a loss function,
wherein each worker corresponds to a tenant within the clustered learning group;
wherein each worker sends partial gradients to a server node,
wherein the server node aggregates the partial gradients received from each worker to merge a final result of a model parameter for the clustered learning group.

11. The computer-implemented supervised similarity measure machine learning method of claim 1, wherein the upward bow pose triggers for the embedding to be re-learned based on an analysis of a probability matrix that is generating based on the embedding.

12. The computer-implemented supervised similarity measure machine learning method of claim 1, wherein the upward bow pose triggers for the embedding to be re-learned when a node owning the data never has a chance to catch the data.

13. The computer-implemented supervised similarity measure machine learning method of claim 1, wherein the upward bow pose triggers for the embeddings to be re-learned based on a scoring gap in a probability matrix generated using the embeddings.

14. The computer-implemented supervised similarity measure machine learning method of claim 11, wherein the clustered learning groups are changed based on the upward bow pose triggering the re-learning.

15. The computer-implemented supervised similarity measure machine learning method of claim 12, wherein the clustered learning groups are changed based on the upward bow pose triggering the re-learning.

16. The computer-implemented supervised similarity measure machine learning method of claim 13, wherein the clustered learning groups are changed based on the upward bow pose triggering the re-learning.

17. The computer-implemented supervised similarity measure machine learning method of claim 1, wherein every learning group contributes to a model in one group after half-distributed.

18. A supervised similarity measure machine learning computer program product, the supervised similarity measure machine learning computer program product comprising a computer-readable storage medium having program instructions embodied therewith, the program instructions executable by a computer to cause the computer to perform:
generating an embedding by training a supervised deep neural network (DNN) on a feature data to determine which node corresponds to which clustered learning group of a plurality of clustered learning groups;
performing a half-distributed learning by distributing data in a time-series database to the plurality of clustered learning groups; and
evaluating, based on the embedding, new tenant data in the plurality of clustered learning groups with an upward bow pose.

19. The supervised similarity measure machine learning computer program product of claim 18, wherein the upward bow pose triggers for the embeddings to be re-learned based on an analysis of a probability matrix that is generating based on the embeddings.

20. The supervised similarity measure machine learning computer program product of claim 18, wherein the upward bow pose triggers for the embeddings to be re-learned when a node owning the data never has a chance to catch the data.

21. The supervised similarity measure machine learning computer program product of claim 18, wherein the upward bow pose triggers for the embeddings to be re-learned based on a scoring gap in a probability matrix generated using the embeddings.

22. A supervised similarity measure machine learning system, said supervised similarity measure machine learning system comprising:
a processor; and
a memory, the memory storing instructions to cause the processor to perform:
generating an embedding by training a supervised deep neural network (DNN) on a feature data to determine which node corresponds to which clustered learning group of a plurality of clustered learning groups;
performing a half-distributed learning by distributing data in a time-series database to the plurality of clustered learning groups; and
evaluating, based on the embedding, new tenant data in the plurality of clustered learning groups with an upward bow pose.

23. The supervised similarity measure machine learning system of claim 22, wherein the upward bow pose triggers for the embeddings to be re-learned based on an analysis of a probability matrix that is generating based on the embeddings.

24. A computer-implemented supervised similarity measure machine learning method, the method comprising:
generating embeddings by training a supervised deep neural network (DNN) on a feature data;
triggering a re-learning of the embeddings via the DNN based on evaluating new tenant data in the clustered learning groups with an upward bow pose.

25. A computer-implemented supervised similarity measure machine learning method, the method comprising:
generating embeddings by training a supervised deep neural network (DNN) on a feature data to determine which nodes correspond to which clustered learning group of clustered learning groups; and
performing multi-thread scoring and learning to re-learn the embeddings based on an evaluation and a prediction for new tenant data of a first thread being different than an evaluation and a prediction of the new tenant data of a second upward bow pose thread.
